(19) United States
(12) Patent Application Publication
(10) Pub. No.: US 2023/0292364 A1
(43) Pub. Date: Sep. 14, 2023

(54) BANDWIDTH RESOURCE MULTIPLEXING METHOD AND APPARATUS, COMMUNICATION DEVICE AND STORAGE MEDIUM

(71) Applicant: Beijing Xiaomi Mobile Software Co., Ltd., Beijing (CN)

(72) Inventor: Qin MU, Beijing (CN)

(21) Appl. No.: 18/006,252

(22) PCT Filed: Jul. 31, 2020
(86) PCT No.: PCT/CN2020/106203

§ 371 Date: Jan. 20, 2023

(51) Int. Cl. H04W 74/08

(52) U.S. Cl. CPC H04W 74/0833; H04W 74/0891

(57) ABSTRACT

A bandwidth resource multiplexing method, includes: sending a resource configuration parameter, a resource indicated by the resource configuration parameter being configured for bandwidth resource multiplexing of a first type of user equipment (UE) and a second type of UE, wherein the bandwidth resource multiplexing includes at least one of: physical random access channel (PRACH) resources of the first type of UE and the second type of UE partially or fully overlapping, or initial uplink (UL) bandwidth parts (BWPs) of the first type of UE and the second type of UE partially or fully overlapping.

### CROSS-REFERENCE TO RELATED APPLICATION

This application is a U.S. national phase application of the International Patent Application No. PCT/CN2020/106203, filed Jul. 31, 2020, the entire contents of which are incorporated herein by reference.

### FIELD

The present disclosure relates to, but is not limited to, the technical field of wireless communication, and more particularly, to a bandwidth resource multiplexing method and apparatus, a communication device, and a storage medium.

### BACKGROUND

In a 4^{th} generation mobile communication (4G) system of long term evolution (LTE), two technologies, i.e., machine type communication (MTC) and a narrow band Internet of Thing (NB-IoT), are proposed to support an IoT service. These two technologies are mainly aimed at scenarios with low rate and high delay, such as meter reading, environmental monitoring, and other scenarios. At present, the NB-IoT can only support a maximum rate of several hundred kbps, and the MTC can only support a maximum rate of several Mbps. However, on the other hand, with the continuous development and popularization of the IoT services, such as video monitoring, smart home, wearable device and industrial sensor monitoring, these services generally require a higher rate of several tens to 100 Mbps and put forward higher requirements for delay. Therefore, the MTC and NB-IoT technologies in the LTE are difficult to meet the requirements. Based on this situation, many companies propose to design a new user equipment in a 5G new radio (NR) to meet the requirements of these mid-range IoT devices. Currently, this new type of terminal is referred to as a reduced capability (RedCap) UE.

Therefore, there exist at least two types of UEs simultaneously in wireless cellular communication, which supports different bandwidths and require different delays. How these two types of UEs use radio resources to reduce unnecessary waste of resources and communication capacity reduction is a problem to be solved.

### SUMMARY

A first aspect of the present disclosure provides a bandwidth resource multiplexing method. The method includes sending a resource configuration parameter, a resource indicated by the resource configuration parameter is configured for bandwidth resource multiplexing of a first type of UE and a second type of UE, and the bandwidth resource multiplexing includes at least one of: physical random access channel (PRACH) resources of the first type of UE and the second type of UE partially or fully overlapping; or initial uplink (UL) bandwidth parts (BWPs) of the first type of UE and the second type of UE partially or fully overlapping.

A second aspect of the present disclosure provides a bandwidth resource multiplexing method, which is applied to a first type of user equipment (UE) and/or a second type of UE. The method includes receiving a resource configuration parameter, a resource indicated by the resource configuration parameter is configured for bandwidth resource multiplexing of the first type of UE and the second type of UE, and the bandwidth resource multiplexing includes at least one of: physical random access channel (PRACH) resources of the first type of UE and the second type of UE partially or fully overlapping, or initial uplink (UL) bandwidth parts (BWPs) of the first type of UE and the second type of UE partially or fully overlapping.

A third aspect of the present disclosure provides a communication device, including a processor, a transceiver; and a memory storing a program executable by the processor, and the processor is configured to perform the method of the first aspect or the second aspect when running the executable program.

A fourth aspect of the present disclosure provides a computer storage medium having stored therein executable programs that, when executed by a processor, cause the processor to perform the method of the first aspect or the second aspect.

It is to be understood that both the foregoing general description and the following detailed description are illustratively and explanatory only and are not restrictive of the present disclosure.

### BRIEF DESCRIPTION OF THE DRAWINGS

The accompanying drawings, which are incorporated in and constitute a part of this specification, illustrate embodiments consistent with the present disclosure and, together with the description, serve to explain the principles of the present disclosure.

FIG. 1 is a schematic diagram showing a wireless communication system according to an embodiment.

FIG. 2 is a flow chart showing a bandwidth resource multiplexing method according to an embodiment.

FIG. 3 is a schematic diagram showing a mapping relationship between synchronization signal blocks (SSBs) and physical random access channel (PRACH) resources according to an embodiment.

FIG. 4A is a schematic diagram showing a mapping relationship between SSBs and PRACH resources according to an embodiment.

FIG. 4B is a schematic diagram showing a mapping relationship between PRACH resources and initial uplink (UL) bandwidth parts (BWPs) according to an embodiment.

FIG. 5A is a flow chart showing a bandwidth resource multiplexing method according to an embodiment.

FIG. 5B is a flow chart showing a bandwidth resource multiplexing method according to an embodiment.

FIG. 6 is a schematic diagram showing a bandwidth resource multiplexing apparatus according to an embodiment.

FIG. 7 is a schematic diagram showing a bandwidth resource multiplexing apparatus according to an embodiment.

FIG. 8 is a schematic diagram showing a UE according to an embodiment.

FIG. 9 is a schematic diagram showing a base station according to an embodiment.

### DETAILED DESCRIPTION

Reference will now be made in detail to illustrative embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the disclosure. Instead, they are merely examples of apparatuses and methods consistent with some aspects of the present disclosure as recited in the appended claims.

Terms used in embodiments of the present disclosure are only for the purpose of describing specific embodiments, but should not be construed to limit embodiments of the present disclosure. As used in embodiments of the present disclosure and the appended claims, “a/an”, “said” and “the” in singular forms are intended to include plural forms, unless clearly indicated in the context otherwise. It should also be understood that, the term “and/or” used herein represents and contains any or all possible combinations of one or more associated listed items.

It should be understood that, although terms such as “first.” “second”, “third” and the like may be used in embodiments of the present disclosure for describing various information, these information should not be limited by these terms. These terms are only used for distinguishing information of the same type from each other. For example, first information may also be referred to as second information, and similarly, the second information may also be referred to as the first information, without departing from the scope of embodiments of the present disclosure. As used herein, the term “if” may be construed to mean “when” or “upon” or “in response to determining” depending on the context.

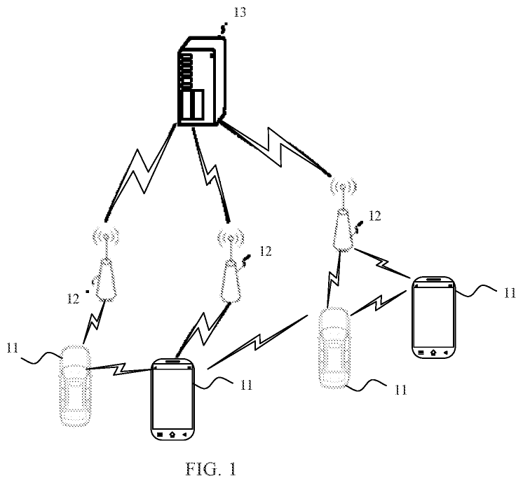

Referring to FIG. 1, which is a schematic diagram showing a wireless communication system provided by embodiments of the present disclosure. As shown in FIG. 1, the wireless communication system is a communication system based on a cellular mobile communication technology, and may include several UEs 11 and several base stations 12.

The UE 11 may refer to a device that provides voice and/or data connectivity for a user. The UE 11 can communicate with one or more core networks via a radio access network (RAN). The UE 11 may be an Internet of Things UE, such as a sensor device, a mobile phone (or referred to as a “cellular” phone) and a computer with an Internet of Things terminal. For example, the UE 11 may be a fixed, portable, pocket-sized, handheld, computer built-in or vehicle-mounted apparatus. For example, the UE 11 may be a station (STA), a subscriber unit, a subscriber station, a mobile station, a mobile, a remote station, an access point, a remote terminal, an access terminal, a user terminal, a user agent, a user device, or a user equipment (UE). Alternatively, the UE 11 may also be a device of an unmanned aerial vehicle. Alternatively, the UE 11 may be a vehicle-mounted device, for example, an electronic control unit with a wireless communication function, or a wireless communication device externally connected with an electronic control unit. Alternatively, the UE 11 may be a roadside device, such as a street lamp, a signal lamp or other roadside devices with a wireless communication function.

The base station 12 may be a network side device in the wireless communication system. The wireless communication system may be a 4th generation mobile communication (4G) system, also referred to as a long term evolution (LTE) system. Alternatively, the wireless communication system may be a 5G system, also referred to as a new radio (NR) system or a 5G NR system. Alternatively, the wireless communication system may be a next generation system of the 5G system. The access network in the 5G system may be referred to as a new generation-radio access network (NG-RAN), or a machine-type communication (MTC) system.

The base station 12 may be an evolved base station (such as an evolved node B, eNB for short) used in the 4G system. Alternatively, the base station 12 may be a base station used in the 5G system which adopts a centralized distributed architecture, such as the next generation node B (gNB). When the base station 12 adopts the centralized distributed architecture, it usually includes a central unit (CU) and at least two distributed units (DUs). The central unit is provided with a protocol stack of a packet data convergence protocol (PDCP) layer, a radio link control (RLC) layer, or a media access control (MAC) layer; and the distributed unit is provided with a protocol stack of a physical (PHY) layer. The specific implementation of the base station 12 is not limited in embodiments of the present disclosure.

A wireless connection can be established between the base station 12 and the UE 11 through a wireless air interface. In different embodiments, the wireless air interface is a wireless air interface based on the 4th generation mobile communication network technology (4G) standard. Alternatively, the wireless air interface is a wireless air interface based on the 5th generation mobile communication network technology (5G) standard. For example, the wireless air interface is a new radio. Alternatively, the wireless air interface may also be a wireless air interface based on a next generation mobile communication network technology standard of the 5G.

In some embodiments, an end to end (E2E) connection may also be established between the UEs 11, for example, a vehicle to vehicle (V2V) communication, a vehicle to infrastructure (V2I) communication and a vehicle to pedestrian (V2P) communication in a vehicle to everything (V2X) communication.

In some embodiments, the above wireless communication system may further include a network management device 13.

Several base stations 12 are connected to the network management device 13, respectively. The network management device 13 may be a core network device in the wireless communication system, for example, the network management device 13 may be a mobility management entity (MME) in an evolved packet core (EPC). Alternatively, the network management device may be other core network devices, such as a serving gateway (SGW), a public data network gateway (POW), a policy and charging rules function (PCRF) or a home subscriber server (HSS). The implementation form of the network management device 13 is not limited in embodiments of the present disclosure.

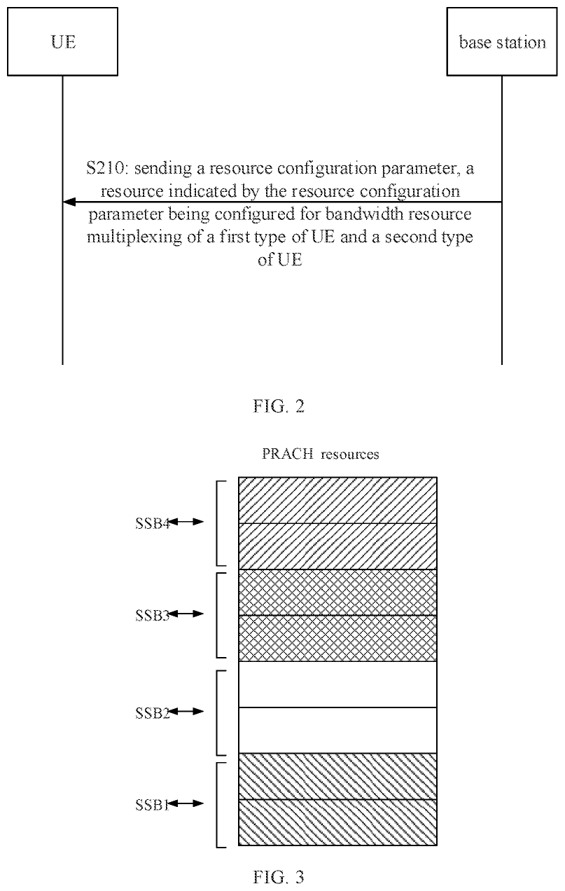

As shown in FIG. 2, embodiments of the present disclosure provide a bandwidth resource multiplexing method. The method includes a step S210.

In step S210, a resource configuration parameter is sent, a resource indicated by the resource configuration parameter is configured for bandwidth resource multiplexing of a first type of UE and a second type of UE, and the bandwidth resource multiplexing includes at least one of: physical random access channel (PRACH) resources of the first type of UE and the second type of UE partially or fully overlapping, or initial uplink (UL) bandwidth parts (BWPs) of the first type of UE and the second type of UE partially or fully overlapping.

The multiplexed resources may be not merely the PRACH resources and/or the initial UL BWPs, but also may be any other appropriate resources, which are not limited by embodiments of the present disclosure.

The bandwidth resource multiplexing method provided by embodiments of the present disclosure can be applied to an access device on a network side. The access device includes, but is not limited to, various types of base stations, for example, an evolved base station (eNB) and/or a next-generation base station (gNB) and/or a base station of any generation communication system.

The resource configuration parameter here may be a configuration parameter for configuring a communication resource to a terminal.

The communication resource includes, but is not limited to, a time domain resource; a frequency domain resource; a time domain-frequency domain resource; a bandwidth resource; or a code domain resource, such as random access preamble or space division multiplexing code, etc.

In embodiments of the present disclosure, the resource indicated by the resource parameter sent for different types of UEs can be multiplexed by the first type of UE and the second type of UE to improve resource utilization. In embodiments of the present disclosure, UEs may be classified into several types of UEs, including but not limited to the first type of UE and the second type of UE, which will not be elaborated herein.

Different types of UEs may be distinguished according to the supported bandwidths. For example, the bandwidth supported by the second type of UE is large, and the bandwidth supported by the first type of UE is small. In some embodiments, the second type of UE may be a normal UE, and the first type of UE may be a reduced capability UE.

Different types of UEs may also be distinguished according to a transceiving capability of the UE. For example, some UEs merely have a single antenna, which cannot perform uplink transmission and downlink transmission simultaneously, so uplink-downlink switching may be required when receiving data. Some UEs have a plurality of antennas, which can perform uplink transmission and downlink transmission simultaneously.

Different types of UEs may also be distinguished according to a service function corresponding to the UE. For example, a smart home device (such as a smart water meter) and a smart office device (such as a smart printer) belong to different functional types of UEs from a mobile phone that communicate with one another.

Because of the differences in communication between different types of UEs, in order to make the communication quality of each type of UE optimal, it may be necessary to allocate resources for these types of UEs separately, which may result in low utilization of communication resources and reduced system capability. In embodiments of the present disclosure, in order to solve the problem of dedicatedly allocating communication resources for each type of UE separately, resources are multiplexed by the first type of UE and the second type of UE. The multiplexed resources here include, but are not limited to, the physical random access channel (PRACH) resources (i.e., PRACH resources) and the initial UL BWPs. For the PRACH and the initial UL BWPs, resources corresponding to different types of UEs may partially or fully overlap. Taking the initial UL BWPs as an example for illustration, the resources corresponding to the first type of UE and the second type of UE may partially or fully overlap. In some embodiments of the present disclosure, the PRACH resources may be used for random access of the UE. In some embodiments of the present disclosure, the initial UL BWPs may be used for initial access of the UE.

In some embodiments of the present disclosure, the UEs may be classified into two or more types.

In embodiments of the present disclosure, the first type of UE and the second type of UE may partially or fully multiplex the PRACH resources based on the resource configuration parameter sent by the base station, and/or, the first type of UE and the second type of UE may partially or fully multiplex the initial UL BWPs based on the resource configuration parameter sent by the base station.

In this way, by at least partially multiplexing the PRACH resources and/or BWP resources by at least two types of UEs, resource waste is reduced, and system capability is improved.

In some embodiments, the at least two types of UEs include a first type of UE and a second type of UE. A bandwidth supported by the first type of UE is smaller than a bandwidth supported by the second type of UE.

For example, the first type of UE may be a reduced capability UE (Redcap UE). The second type of UE may be an NR UE.

The Redcap UE has the following characteristics: low cost, low complexity, a certain degree of coverage enhancement, and low power consumption.

For example, in order to meet the requirements of low cost and low complexity, a radio frequency (RF) bandwidth of Redcap may be limited, for example, to 5 MHz or 10 MHz, or a buffer capacity of Redcap is limited, so as to limit a size of each received transmission block. For power saving, a possible optimization direction is to simplify a communication process, reduce the number of times that the Redcap UE detects the downlink control channel, and the like.

In summary, in an embodiment, different types of UEs are classified according to a bandwidth supported by a UE, for example, classified according to a maximum bandwidth supported by a UE.

In some embodiments of the present disclosure, the first type of UE and the second type of UE may multiplex at least part of PRACH resources, and/or the first type of UE and the second type of UE may multiplex at least part of the initial UL BWPs.

In an embodiment, the resource configuration parameter includes at least one set of configuration parameters, and the at least one set of configuration parameters is configuration parameters dedicated to the first type of UE.

In an embodiment, the resource configuration parameter include at least two sets of configuration parameters, of which at least one set of resource parameters corresponds to the first type of UE.

In some embodiments of the present disclosure, taking the UEs including the first type of UE and the second type of UE as an example for illustration. Certainly, other types of UE may also be included, which is not limited in embodiments of the present disclosure. In some embodiments of the present disclosure, the resource configuration parameter at least includes a first set of configuration parameters for the first type of UE, and a second set of configuration parameters for the second type of UE.

For this, when sending the resource configuration parameter, the base station may broadcast the resource configuration parameter carrying a plurality of sets of configuration parameters to all UEs in a cell, or send at least one set of configuration parameters corresponding to a certain type of UE separately. For example, the first set of configuration parameters corresponding to the first type of UE is sent to the first type of UE by multicast or unicast, and the second set of configuration parameters corresponding to the second type of UE is sent to the second type of UE by multicast or unicast.

In some embodiments of the present disclosure, the resource configuration parameter includes one or more sets of configuration parameters, in which any set of configuration parameters may include at least one of the following parameters: indication parameters for random access preamble sets, random access preambles corresponding to random access preamble sets corresponding to the first type of UE and the second type of UE being different; resource parameters for the PRACH resources, the PRACH resources corresponding to the first type of UE and the second type of UE at least partially overlapping; resource parameters for the initial UL BWPs, the initial UL BWPs corresponding to the first type of UE and the second type of UE at least partially overlapping; a mapping relationship between synchronization signal blocks (SSBs) and PRACH resources, which enables the first type of UE and/or the second type of UE to determine a PRACH resource used according to an accessed SSB; or indication parameters for a mapping relationship between PRACH resources and initial UL BWPs, which enables the first type of UE and/or the second type of UE to determine an initial UL BWP used according to a PRACH resource used.

In some embodiments of the present disclosure, the resource configuration parameter may include the indication parameters for the random access preamble sets, the random access preambles corresponding to the random access preamble sets corresponding to the first type of UE and the second type of UE are different. In some embodiments of the present disclosure, each random access preamble set may include one or more random access preambles. Since at least two types of UEs multiplex the PRACH resources and/or the initial UL BWPs indicated by the resource configuration parameter, in order to facilitate the base station to distinguish which type of UE is currently accessed from the multiplexed PRACH resource, different random access preamble sets will be allocated to different types of UE.

In some embodiments of the present disclosure, the indication parameters may be a set index of a random access preamble set, or an index of a random access preamble included in the random access preamble set, or the like. In some embodiments of the present disclosure, an index of the random access preamble/random access preamble set may be specified by a communication protocol, or configured to the UE by the network side. In some embodiments of the present disclosure, the indication parameters may be the random access preamble/random access preamble set itself corresponding to the first type of UE and/or the second type of UE.

In some embodiments of the present disclosure, it also possible to use a combination of the index of the random access preamble/random access preamble set described above and the random access preamble/random access preamble set itself described above. That is, the indication parameters not only include the index of the random access preamble/random access preamble set, but also include the random access preamble/random access preamble set itself. Alternatively, the indication parameters include the index of the random access preamble/random access preamble set corresponding to a part of UEs, and the random access preamble/random access preamble set itself corresponding to a part of UEs.

In summary, the indication parameters may be various information or data indicating the random access preamble/random access preamble set configured for the UE.

Each random access preamble sets includes one or more random access preambles. Different random access preamble sets include different random access preambles. Therefore, when receiving a random access request on a PRACH resource multiplexed by a plurality of types of UEs, the base station determines the type of the UE currently requesting random access according to an indication parameter of the random access preamble set to which the random access preamble carried in the random access request belongs, and then comprehensively determines whether to respond to the random access of the UE according to the type of UE, a quality of service (QoS) of a service corresponding to the type of UE, a current load status of the network, and access rates of various UEs.

In an embodiment, the resource parameters for the PRACH resources indicate the PRACH resources. For example, the resource parameters for the PRACH resources are configured for each type of UE. The resource parameters can indicate the PRACH resources, including at least one of the following resources: a time domain resource, a frequency domain resource, or a code domain resource.

The resource parameters for the initial UL BWPs may indicate resources for the corresponding UE to perform initial access, including at least one of the following resources: a time domain resource, a frequency domain resource, or a code domain resource.

The UE needs to perform downlink synchronization with the network side when accessing. The base station at the network side will send a synchronization signal block, which includes, but is not limited to, a primary synchronization signal and/or a secondary synchronization signal.

To reduce the slippage of a bandwidth frequency supported by a UE, the SSB, the PRACH resources, and the initial UL BWPs of the same type of UE have a certain correlation. For example, the bandwidth of the SSB is at least partially covered by the bandwidth of the PRACH resources, and the bandwidth of the initial UL BWPs at least partially covers at least part of the bandwidth of the PRACH resources used by the UE. Therefore, in an embodiment, the resource configuration parameter may indicate the mapping relationship between the SSBs and the PRACH resources.

For example, N PRACH resources are configured through the resource parameters of the PRACH resources, and one SSB has a mapping relationship with one PRACH resource, so that after accessing to one of the N SSBs, the UE selects the PRACH resource corresponding to the accessed SSB for random access according to the mapping relationship. In other embodiments, the one SSB may correspond to a plurality of PRACH resources.

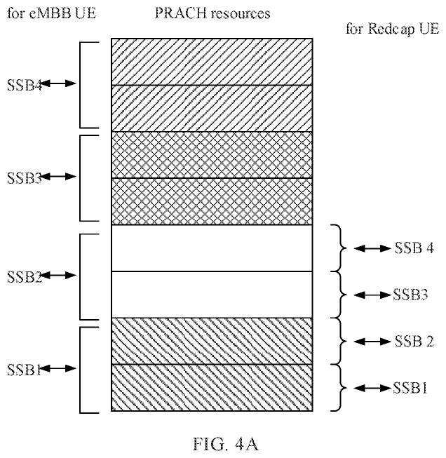

Referring to FIG. 3, the resource configuration parameter is configured with four SSBs, namely SSB1 to SSB4. One SSB corresponds to two PRACH resources.

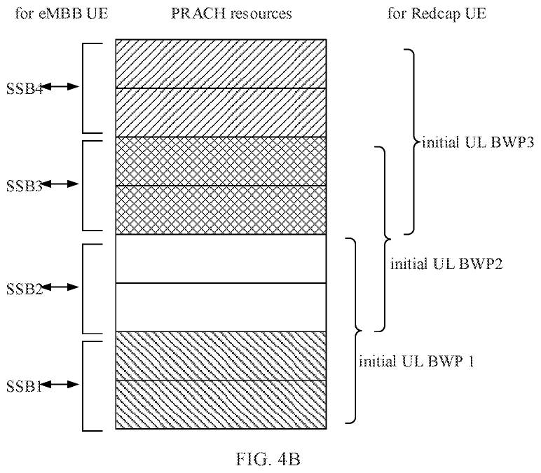

Referring to FIG. 4A, four SSBs are configured for an enhanced mobile bandwidth (eMBB) UE, and one SSB corresponds to two PRACH resources. Also, four SSBs are configured for a Redcap UE, and each of the four SSBs corresponds to one PRACH resource, respectively.

Here, the eMBB UE is one of the above-mentioned second type of UE.

In this way, it can be seen that the first type of UE multiplexes a part of the PRACH resources of the second type of UE, and the part of the PRACH resources multiplexed by the first type of UE is continuously distributed in a frequency domain.

In an embodiment, the bandwidths of the PRACH resources used by two types of UEs that support different bandwidths may be the same or different. For example, in an embodiment, the bandwidth of the PRACH resource used by the first type of UE for random access may be smaller than the bandwidth of the PRACH resource used by the second type of UE for random access.

In other embodiments of the present disclosure, since the bandwidths supported by the first type of UE and the second type of UE are different, the bandwidths of the initial UL BWPs used by the at least two types of UEs are different. For example, the bandwidth of the initial UL BWP used by the first type of UE is smaller than that of the initial UL BWP used by the second type of UE.

In some embodiments of the present disclosure, the resource configuration parameter includes a third set of configuration parameters corresponding to the first type of UE and the second type of UE.

In other words, the resource configuration parameter includes the third set of configuration parameters corresponding to both the first type of UE and the second type of UE.

In some embodiments of the present disclosure, the resource configuration parameter at least include one set of resource configuration parameters corresponding to the first type of UE and the second type of UE. That is, different types of UEs share a same set of resource configuration parameters.

Therefore, the third set of configuration parameters is received by different types of UEs, respectively. When performing the resource multiplexing, a UE performs the resource multiplexing based on a resource multiplexing mechanism corresponding to its type according to the resource configuration parameter.

For example, the third set of configuration parameters is configured according to the second type of UE that supports a large bandwidth. The first type of UE receives the third set of configuration parameters, and multiplexes some or all of the PRACH resources of the second type of UE, and/or some or all of the initial UL BWP of the second type of UE according to the third set of configuration parameters and its resource multiplexing mechanism of multiplexing the PRACH resources and/or the initial UL BWPs of the second type UE.

With this resource configuration parameter, the signaling overhead is reduced because the resource parameters are obtained without separately configuring resources for each type of UE.

In some embodiments, the third set of configuration parameters includes at least one of the following parameters: indication parameters for a random access preamble set corresponding to the first type of UE and the second type of UE, respectively; resource parameters for PRACH resources corresponding to both the first type of UE and the second type of UE; or indication parameters for a mapping relationship between SSBs and PRACH resources that corresponds to both the first type of UE and the second type of UE.

Similarly, the third set of configuration parameters here includes indication parameters for a random access preamble set corresponding to different types of UEs, respectively, so that the network side can distinguish the type of a device currently requesting the random access according to a random access preamble carried in a random access request.

In other embodiments, the indication parameters for a random access preamble set included in the third set of configuration parameters may also be directed at different types of UEs. In this case, different types of UEs will use random access preambles in a same random access preamble set for random access. When needed subsequently, the base station may determine the type of the UE according to an information content sent by the UE after or during the random access.

With regard to the indication parameters for the random access preamble set, the resource parameters, and the mapping relationship mentioned here, reference may be made to the relevant descriptions of above embodiments, which will not be elaborated herein.

In some embodiments, the mapping relationship between the SSBs and the PRACH resources is configured for a UE to determine a PRACH resource used according to an accessed SSB.

The mapping relationship between the SSBs and the PRACH resources can be applied to both the first type of UE and the second type of UE. Therefore, after receiving the mapping relationship indicated by the third set of configuration parameters, the UE can perform random access on the PRACH resource corresponding to the accessed SSB corresponding to the type of UE according to the mapping relationship.

In embodiments of the present disclosure, at least two different types of UEs may use a same mapping relationship between the SSBs and the PRACH resources to determine the PRACH resources for random access by the UE.

In some embodiments, the third set of configuration parameters further includes a mapping relationship between the PRACH resources and the initial UL BWPs corresponding to the second type of UE.

For example, UEs includes the first type of UE and the second type of UE, and a bandwidth supported by the second type of UE is larger than a bandwidth supported by the first type of UE. In this case, the indication parameter for the mapping relationship carried by the third set of configuration parameters may be the mapping relationship between the PRACH resources and the initial UL BWPs corresponding to the second type of UE.

In some embodiments of the present disclosure, the indication parameter for this mapping relationship may include an index indication for indicating the mapping relationship, and may also be embodied by an association relationship between the PRACH resources and resource indexes of the initial UL BWPs.

In some embodiments, sending the resource configuration parameter includes sending the resource configuration parameter via remaining minimum system information (RMSI).

In some embodiments of the present disclosure, the resource configuration parameter is sent via the RMSI. In other embodiments of the present disclosure, the resource configuration parameter may also be sent via an RRC message or a MAC CE.

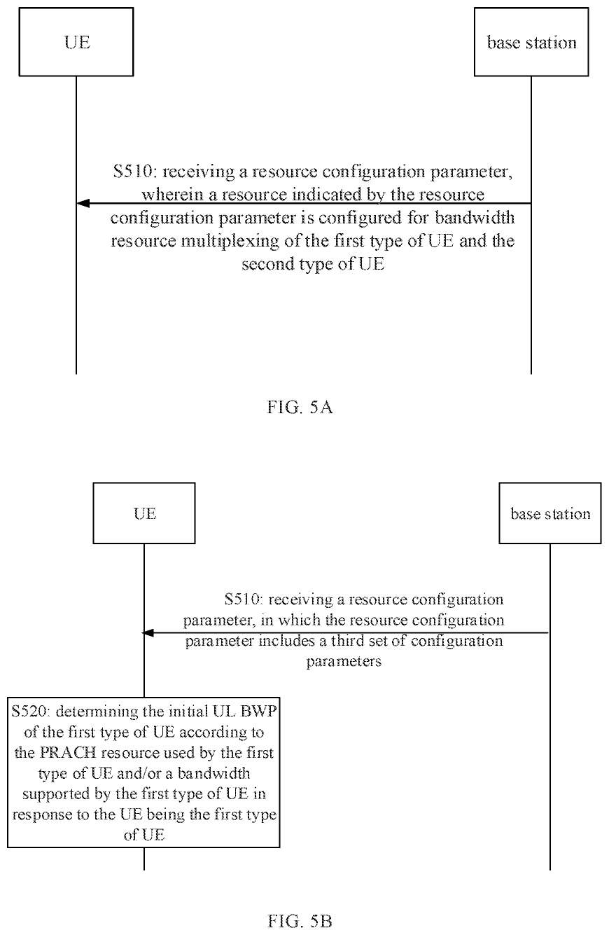

As shown in FIG. 5A, embodiments of the present disclosure provide a bandwidth resource multiplexing method, which is applied to a user equipment (UE). The method includes a step S510.

In step S510, a resource configuration parameter is received, a resource indicated by the resource configuration parameter is configured for bandwidth resource multiplexing of the first type of UE and the second type of UE, and the bandwidth resource multiplexing includes at least one of: physical random access channel (PRACH) resources of the first type of UE and the second type of UE partially or fully overlapping, or initial uplink (UL) bandwidth parts (BWPs) of the first type of UE and the second type of UE partially or fully overlapping.

Embodiments of the present disclosure are applied to a UE, including but not limited to a first type of UE and a second type of UE. The UE may be various types of UEs. A bandwidth supported by the second type of UE is greater than a bandwidth supported by the first type of UE, or a bandwidth supported by the second type of UE is equal to a bandwidth supported by the first type of UE.

Here, the bandwidth supported by the first type of UE may be considered as a maximum bandwidth over which the first type of UE can operate, and the bandwidth supported by the second type of UE may be considered as a maximum bandwidth over which the second type of UE can operate.

In general, different types of UEs will receive the resource configuration parameter from the base station, and then configure the parameter according to the resource. Therefore, different types of UEs can multiplex resources. For example, the PRACH resources are multiplexed, and/or the initial UL BWPs are multiplexed.

In an embodiment of the present disclosure, the UE receives, according to its own type, a set of configuration parameters for this type of UE sent by the base station. In another embodiment of the present disclosure, the resource configuration parameter sent by a network side device (such as a base station) is directed at a plurality of types of UEs, so the UE receives the resource configuration parameters directed at the plurality of types of UEs. For example, the resource configuration parameter directed at a plurality of types of UEs includes sets of respective resource configuration parameters of at least two types of UEs, and a UE determines the resource configuration parameter corresponding to the UE from the sets of resource configuration parameters according to its own type. For another example, a plurality of types of UEs share a same set of resource configuration parameter, and a UE determines the resource configuration parameter according to its own type.

In an embodiment, the step S510 may include receiving a configuration parameter corresponding to the type of the UE according to the type of the UE.

For example, UEs may be classified into at least a first type of UE and a second type of UE. If a current UE is the first type of UE, a first set of configuration parameters for the first type of UE is received from the base station. If a current UE is the second type of UE, a second set of configuration parameters for the second type of UE is received from the base station.

The resource configuration parameter includes at least one of the following parameters: indication parameters for random access preamble sets, random access preambles contained in random access preamble sets corresponding to the first type of UE and the second type of UE are different; resource parameters for the PRACH resources, at least portions of the PRACH resources corresponding to the first type of UE and the second type of UE overlapping; resource parameters for the initial UL BWPs, at least portions of the initial UL BWPs corresponding to the first type of UE and the second type of UE overlapping; indication parameters for a mapping relationship between synchronization signal blocks (SSBs) and PRACH resources, the mapping relationship between the SSBs and the PRACH resources being configured for the first type of UE and/or the second type of UE to determine a PRACH resource used according to an accessed SSB; or indication parameters for a mapping relationship between PRACH resources and initial UL BWPs, the mapping relationship between the PRACH resources and the initial UL BWPs being configured for the first type of UE and/or the second type of UE to determine an initial UL BWP used according to a PRACH resource used.

In another embodiment, the step S510 may include receiving a third set of configuration parameters for at least two types of UEs simultaneously.

In some embodiments of the present disclosure, a plurality of types of UEs perform bandwidth resource multiplexing, and the base station merely sends one set of configuration parameters, then the plurality of types of UEs all receive a same set of configuration parameters, and then directly use the received configuration parameters.

The UE that has received the third set of configuration parameters performs the bandwidth resource multiplexing with other types of UEs according to at least one parameter of mechanism information of a locally stored resource multiplexing mechanism, a resource multiplexing mechanism specified by a communication protocol, and the received configuration parameters. For example, all or part of the PRACH resources are multiplexed, and/or, all or part of the initial UL BWPs resources are multiplexed.

In an embodiment, the third set of configuration parameters includes at least one of the following parameters: indication parameters for a random access preamble set corresponding to the first type of UE and the second type, respectively; resource parameters for PRACH resources corresponding to both the first type of UE and the second type of UE; or indication parameters for a mapping relationship between SSBs and PRACH resources that corresponds to both the first type of UE and the second type.

With regard to specific contents carried in the third set of configuration parameters here, reference can be made to embodiments regarding the base station side, which will not be elaborated herein.

In some embodiments, the mapping relationship between the SSBs and the PRACH resources is configured for the UE to determine a PRACH resource used according to an accessed SSB.

In some embodiments, in response to determining that the resource configuration parameter includes the third set of configuration parameter, different types of UEs may use the PRACH resources with a same bandwidth size for random access, and determine the PRACH resources used according to a same mapping relationship between the SSBs and the PRACH resources.

In some embodiments, the third set of configuration parameters further includes indication parameters for a mapping relationship between the PRACH resources and the initial UL BWPs corresponding to the second type of UE.

For example, the third set of configuration parameters directly indicates the mapping relationship between the initial UL BWPs and the PRACH resources of the UE (for example, the second type of UE) that supports a largest bandwidth among the at least two types of UEs, so the second type of UE directly determines an initial UL BWP used thereby according to the mapping relationship indicated by the third set of configuration parameters. The first type of UE or other types of UEs may determine the initial UL BWPs used according to the PRACH resources used by themselves and the bandwidth supported by themselves.

For example, as shown in FIG. 5B, the method further includes a step S520.

In step S520, the initial UL BWP of the first type of UE is determined according to the PRACH resource used by the first type of UE and/or a bandwidth supported by the first type of UE in response to the UE being the first type of UE.

For example, in response to determining that the first type of UE uses a PRACH resource m for random access, the first type of UE may use the PRACH resource m as a lowest frequency bandwidth resource, and expand a bandwidth supported by itself to a high frequency direction to determine the initial UL BWP used by itself.

For another example, the first type of UE may also use the PRACH resource m as a central bandwidth, and expand a bandwidth supported by itself to both a high frequency direction and a low frequency direction to obtain the initial UL BWP used by itself.

For another example, the first type of UE may also use the PRACH resource m as a highest frequency bandwidth resource, and expand a bandwidth supported by itself to a low frequency direction to obtain the initial UL BWP used by itself.

In an embodiment, the first type of UE may determine a direction of bandwidth width expansion according to a bandwidth indicated by itself and a frequency of the PRACH resource currently used by itself for random access. For example, the frequency expansion direction is determined to be expansion toward a low frequency direction in response to determining that the PRACH resource currently used by the first type of UE is a PRACH resource with a highest frequency configured by the third set of configuration parameters. For another example, the frequency expansion direction is determined to be expansion toward a high frequency direction in response to determining that the PRACH resource currently used by the first type of UE is a PRACH resource with a lowest frequency configured by the third set of configuration parameter. For example, the frequency expansion direction can be randomly determined, for example, the expansion direction may be the low frequency direction, the high frequency direction, or both the high frequency and the low frequency directions, in response to determining that the PRACH resource currently used has a middle frequency configure by the third set of configuration parameters.

In some embodiments, the first type of UE may directly use a bandwidth of a predetermined multiple of the PRACH resource used by itself as the initial UL BWP used by itself. The predetermined multiple may be predefined, or specified by a communication protocol, or configured by a network side device through a message. In this case, the PRACH resource used by the first type of UE can be used as a subband at any position in the initial UL BWP.

In some embodiments, the initial UL BWP finally used by the first type of UE may be a subband of the initial UL BWP of the second type of UE.

Referring to FIG. 4B, SSB1 corresponds to the bottom two PRACH resources in FIG. 4B.

If the Redcap UE receives a synchronization signal sent by the base station from the SSB1, it is determined that the Redcap UE performs the random access from the bottom two PRACH resources in FIG. 4B corresponding to the SSB1. Further, the Redcap UE slides up two PRACH resources to obtain an initial UL BWP1 shown in FIG. 4B based on the bottom two PRACH resources in FIG. 4B.

As can be seen from FIG. 4B, even if a UE supporting a narrower bandwidth is within the initial UL BWP of a UE supporting a larger bandwidth, the UE supporting a narrower bandwidth will obtain the initial UL BWP used by itself according to the PRACH resource used by itself and in combination with the bandwidth supported by itself.

Referring to FIG. 4B, according to this resource multiplexing mechanism, three initial UL BWPs for use by the first type of UE, such as an initial UL BWP1, an initial UL BWP2 and an initial UL BWP3 as shown in FIG. 4B, respectively, can be obtained on the initial UL BWP of the second type of UE, according to the PRACH resource and the bandwidth supported by the first type of UE. Referring to FIG. 4B, the first type of UE can multiplex different bandwidth resources as the initial UL BWPs in a balanced manner. FIG. 4B is merely an example, and a specific implementation is not limited thereto.

In an embodiment, receiving the resource configuration parameter includes receiving the resource configuration parameter via remaining minimum system information (RMSI).

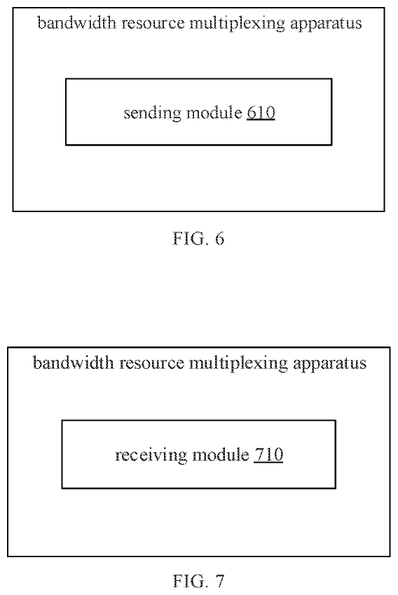

As shown in FIG. 6, embodiments of the present disclosure provide a bandwidth resource multiplexing apparatus. The apparatus includes a sending module 610. The sending module 610 is configured to send a resource configuration parameter, a resource indicated by the resource configuration parameter is configured for bandwidth resource multiplexing of a first type of UE and a second type of UE, and the bandwidth resource multiplexing includes at least one of: physical random access channel (PRACH) resources of the first type of UE and the second type of UE partially or fully overlapping, or initial uplink (UL) bandwidth parts (BWPs) of the first type of UE and the second type of UE partially or fully overlapping.

In some embodiments, the sending module 610 may be a program module. The program module can realize the sending of the resource configuration parameter when executed by a processor.

In another embodiment, the sending module 610 may be a software-hardware combined module. The software-hardware combined module includes, but is not limited to, a programmable array. The programmable array includes a complex programmable array and/or a field programmable array.

In some embodiments, the sending module 610 may be a pure hardware module. The pure hardware module includes, but is not limited to, a pure hardware module. The pure hardware module includes an application-specific integrated circuit.

In some embodiments, the at least two types of UEs support different bandwidths. A bandwidth supported by the second type of UE is greater than a bandwidth supported by the first type of UE, or a bandwidth supported by the second type of UE is equal to a bandwidth supported by the first type of UE.

In some embodiments, the resource configuration parameter includes at least two sets of configuration parameters, in which at least one set of configuration parameters is configuration parameters dedicated to the first type of UE.

In some embodiments, the resource configuration parameter includes at least one of the following parameters: indication parameters configured to indicate random access preamble sets, random access preambles contained in random access preamble sets corresponding to the first type of UE and the second type of UE being different; resource parameters for the PRACH resources, at least portions of the PRACH resources corresponding to the first type of UE and the second type of UE overlapping; resource parameters for the initial UL BWPs, at least portions of the initial UL BWPs corresponding to the first type of UE and the second type of UE overlapping, indication parameters for a mapping relationship between synchronization signal blocks (SSBs) and PRACH resources, the mapping relationship between the SSBs and the PRACH resources being configured for the first type of UE and/or the second type of UE to determine a PRACH resource used according to an accessed SSB; or indication parameters for a mapping relationship between PRACH resources and initial UL BWPs, the mapping relationship between the PRACH resources and the initial UL BWPs being configured for the first type of UE and/or the second type of UE to determine an initial UL BWP used according to a PRACH resource used.

In some embodiments, the resource configuration parameter include a third set of configuration parameters corresponding to the first type of UE and the second type of UE.

In some embodiments, the third set of configuration parameters includes at least one of the following parameters: indication parameters for a random access preamble set corresponding to the first type of UE and the second type of UE, respectively; resource parameters for PRACH resources corresponding to both the first type of UE and the second type; or indication parameters for a mapping relationship between SSBs and PRACH resources that corresponds to both the first type of UE and the second type.

In some embodiments, the mapping relationship between the SSBs and the PRACH resources is configured for the UE to determine a PRACH resource used according to an accessed SSB.

In some embodiments, the third set of configuration parameters further includes indication parameters for a mapping relationship between the PRACH resources and the initial UL BWPs for a type of UE that supports a larger bandwidth of the at least two types of UEs.

In some embodiments, sending the resource configuration parameter for bandwidth resource multiplexing of at least two types of UEs that support different bandwidths includes: sending the resource configuration parameter for the bandwidth resource multiplexing of the at least two types of UEs that support different bandwidths via remaining minimum system information (RMSI).

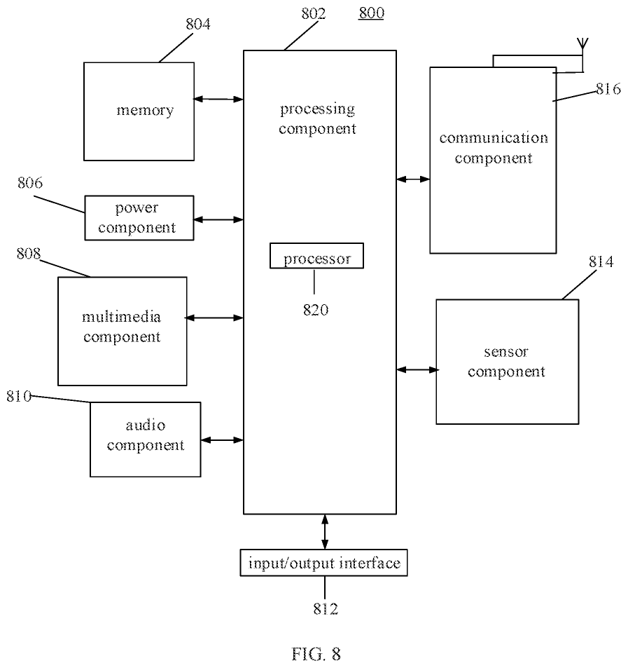

As shown in FIG. 7, embodiments of the present disclosure provide a bandwidth resource multiplexing apparatus, which is applied to a user equipment (UE). The apparatus includes a receiving module 710.

The receiving module 710 is configured to receive a resource configuration parameter, a resource indicated by the resource configuration parameter is configured for bandwidth resource multiplexing of the first type of UE and the second type of UE, and the bandwidth resource multiplexing includes at least one of: physical random access channel (PRACH) resources of the first type of UE and the second type of UE partially or fully overlapping, or initial uplink (UL) bandwidth parts (BWPs) of the first type of UE and the second type of UE partially or fully overlapping.

In some embodiments, the receiving module 710 may be a program module. The program module can realize the receiving of the resource configuration parameter when executed by a processor.

In another embodiment, the receiving module 710 may be a software-hardware combined module. The software-hardware combined module includes, but is not limited to, a programmable array. The programmable array includes a complex programmable array and/or a field programmable array.

In still other embodiments, the receiving module 710 may be a pure hardware module. The pure hardware module includes, but is not limited to, a pure hardware module. The pure hardware module includes an application-specific integrated circuit.

In some embodiments, the receiving module 710 is configured to receive a configuration parameter of the type of the UE according to the type of the UE.

In some embodiments, a bandwidth supported by the second type of UE is greater than a bandwidth supported by the first type of UE, or a bandwidth supported by the second type of UE is equal to a bandwidth supported by the first type of UE.

In some embodiments, the resource configuration parameter include at least one of the following parameters: indication parameters for random access preamble sets, random access preambles contained in random access preamble sets corresponding to the first type of UE and the second type of UE are different; resource parameters for the PRACH resources, at least portions of the PRACH resources corresponding to the first type of UE and the second type of UE overlapping: resource parameters for the initial UL BWPs, at least portions of the initial UL BWPs corresponding to the first type of UE and the second type of UE overlapping; indication parameters for a mapping relationship between synchronization signal blocks (SSBs) and PRACH resources, the mapping relationship between the SSBs and the PRACH resources being configured for the first type of UE and/or the second type of UE to determine a PRACH resource used according to an accessed SSB; or indication parameters for a mapping relationship between PRACH resources and initial UL BWPs, the mapping relationship between the PRACH resources and the initial UL BWPs being configured for the first type of UE and/or the second type of UE to determine an initial UL BWP used according to a PRACH resource used.

In some embodiments, the receiving module 710 is configured to receive a third set of configuration parameters corresponding to the first type of UE and the second type of UE.

In some embodiments, the third set of configuration parameters includes at least one of the following parameters: indication parameters for a random access preamble set corresponding to the first type of UE and the second type, respectively; resource parameters for PRACH resources corresponding to both the first type of UE and the second type of UE; or indication parameters for a mapping relationship between SSBs and PRACH resources that corresponds to both the first type of UE and the second type.

In some embodiments, the mapping relationship between the SSBs and the PRACH resources is configured for the UE to determine a PRACH resource used according to an accessed SSB.

In some embodiments, the third set of configuration parameters further includes: indication parameters for a mapping relationship between the PRACH resources and the initial UL BWPs corresponding to the second type of UE.

In some embodiments, the apparatus further includes a determining module.

The determining module is configured to determine the initial UL BWP of the first type of UE according to the PRACH resource used by the first type of UE and/or a bandwidth supported by the first type of UE in response to the UE being the first type of UE.

In some embodiments, receiving the resource configuration parameter includes receiving the resource configuration parameter via remaining minimum system information (RMSI).

In some embodiments of the present disclosure, there is provided a solution that supports multiplexing of PRACH resources between a Redcap UE and a normal NR terminal, and two optional specific implementation solutions are provided below.

Implementation Solution 1: Centralized Multiplexing

Optional PRACH resources allocated to all Redcap UEs are concentrated in a part of PRACH resources allocated to normal NR terminals, as shown in FIG. 4A.

Initial UL BWP for the Redcap UE is configured in RMSI, and the PRACH resources allocated to normal terminals and contained in the initial UL BWP are PRACH resources allocated to the Redcap UE. Alternatively, the PRACH resources of the Redcap UE is directly configured by RMSI.

On the overlapping PRACH resources of the two types of terminals, the two types of terminals use different preamble sets. Different preamble sets contain different preambles. Therefore, an access network can determine whether a terminal currently requesting access is a Redcap terminal or an NR terminal according to difference preambles sent on the same PRACH resource.

Implementation Solution 2: Decentralized Multiplexing

Referring to FIG. 4B, a plurality of initial UL BWPs or PRACH resource sets are configured, and the plurality of initial BWPs or PRACH resource sets include PRACH resources partially allocated to the normal NR terminals.

The Redcap UE chooses which initial UL BWP or PRACH resource set to use according to a specific criteria.

For example, the Redcap UE determines which PRACH resource or initial UL BWP to use according to the SSB used during access.

The determination of the plurality of initial UL BWPs may be configured by RMSI, or may be determined according to the PRACH resource selected by the terminal. For example, when a user equipment accesses via SSB1, the initial UL BWP is determined by using the PRACH resource corresponding to SSB1 of an eMBB user equipment as a starting point and adding bandwidth of the user equipment, and the PRACH resource corresponding to the SSB1 of the eMBB user equipment is used for access.

The PRACH resource supporting the Redcap UE is multiplexed with the PRACH resource of normal NR.

Embodiments of the present disclosure provide a communication device, including a processor, a transceiver, a memory, and an executable program stored in the memory and executable by the processor, and the processor is configured to execute the bandwidth resource multiplexing method applied to an UE or a base station provided by any of the above-mentioned technical solutions when running the executable program.

The communication device may be the above-mentioned base station or UE.

The processor may include various types of storage media that are non-transitory computer storage media that can continue to remember the information stored thereon after the communication device is powered down. Here, the communication device includes a base station or a user equipment.

The processor may be connected to the memory via a bus or the like, for reading the executable program stored in the memory, for example, at least one of the methods shown in FIG. 2, FIG. 5A, and FIG. 5B.

Embodiments of the present disclosure provide a computer storage medium having stored therein executable programs that, when executed by a processor, cause the method shown in any technical solution of the first aspect or the second aspect, for example, at least one of the methods shown in FIG. 2, FIG. 5A, and FIG. 5B, to be implemented.

FIG. 8 is a block diagram showing a user equipment (UE) 800 according to an embodiment. For example, the UE 800 can be a mobile phone, a computer, a digital broadcast user device, a messaging device, a game console, a tablet device, a medical device, a fitness device, a personal digital assistant, or the like.

Referring to FIG. 8, the UE 800 may include one or more of the following components: a processing component 802, a memory 804, a power component 806, a multimedia component 808, an audio component 810, an input/output (I/O) interface 812, a sensor component 814, and a communication component 816.

The processing component 802 typically controls overall operations of the UE 800, such as the operations associated with display, phone calls, data communications, camera operations, and recording operations. The processing component 802 can include one or more processors 820 to execute instructions to perform all or some of the steps in the above-described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the UE 800. Examples of such data include instructions for any applications or methods operated on the UE 800, contact data, phonebook data, messages, pictures, videos, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the UE 800. The power component 806 may include a power management system, one or more power sources, and any other components associated with the generation, management, and distribution of power in the UE 800.

The multimedia component 808 includes a screen providing an output interface between the UE 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front camera and/or a rear camera. The front camera and/or the rear camera may receive an external multimedia datum while the UE 800 is in an operation mode, such as a photographing mode or a video mode. Each of the front camera and the rear camera may be a fixed optical lens system or have focus and optical zoom capability.

The audio component 810 is configured to output and/or input audio signals. For example, the audio component 810 includes a microphone (MIC) configured to receive an external audio signal when the UE 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 812 provides an interface between the processing component 802 and peripheral interface modules, such as keyboards, click wheels, buttons, and the like. The buttons may include, but are not limited to, a home button, a volume button, a starting button, and a locking button.

The sensor component 814 includes one or more sensors to provide status assessments of various aspects of the UE 800. For instance, the sensor component 814 may detect an open/closed status of the UE 800, relative positioning of components, e.g., the display and the keypad, of the UE 800, a change in position of the UE 800 or a component of the UE 800, a presence or absence of user contact with the UE 800, an orientation or an acceleration/deceleration of the UE 800, and a change in temperature of the UE 800. The sensor component 814 may include a proximity sensor configured to detect the presence of nearby objects without any physical contact. The sensor component 814 may further include a light sensor, such as a CMOS or CCD image sensor, for use in imaging applications. In some embodiments, the sensor component 814 may further include an accelerometer sensor, a gyroscope sensor, a magnetic sensor, a pressure sensor, or a temperature sensor.

The communication component 816 is configured to facilitate communication, wired or wireless, between the UE 800 and other devices. The UE 800 can access a wireless network based on a communication standard, such as WiFi, 2G, 3G, 4G LTE, 5G NR, or a combination thereof. In an embodiment, the communication component 816 receives a broadcast signal or broadcast associated information from an external broadcast management system via a broadcast channel. In an embodiment, the communication component 816 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In an embodiment, the UE 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic elements, for performing the above-mentioned method.

In an embodiment, there is also provided a non-transitory computer readable storage medium including instructions, such as included in the memory 804, executable by the processor 820 in the UE 800, for completing the above-mentioned method. For example, the non-transitory computer-readable storage medium may be a ROM, a random access memory (RAM), a CD-ROM, a magnetic tape, a floppy disc, an optical data storage device, and the like.

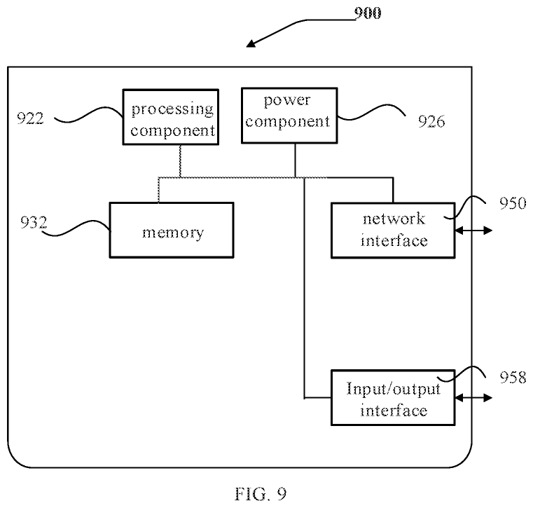

As shown in FIG. 9, an embodiment of the present disclosure shows a structure of a base station. For example, the base station 900 may be provided as a network side device. Referring to FIG. 9, the base station 900 includes a processing component 922, which further includes one or more processors, and a memory resource represented by a memory 932 for storing an instruction, such as an application program, executable by the processing component 922. The application program stored in the memory 932 may include one or more modules, each of which corresponds to a set of instructions. Additionally, the processing component 922 is configured to execute instructions to perform any of above-mentioned methods applied to the base station, for example, the methods shown in FIG. 2 and FIG. 3.

The base station 900 may also include: a power component 926 configured to perform power management of the base station 900, a wired or wireless network interface 950 configured to connect the base station 900 to a network, and an input/output (I/O) interface 958. The base station 900 may operate based on an operating system stored in the memory 932, such as Windows Server™, Mac OS X™, Unix™, Linux™, FreeBSD™, or the like.

Other embodiments of the present disclosure will be apparent to those skilled in the art from consideration of the specification and practice of the present disclosure described here. The present disclosure is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the present disclosure being indicated by the following claims.

It will be appreciated that the present disclosure is not limited to the exact construction that has been described above and illustrated in the accompanying drawings, and that various modifications and changes can be made without departing from the scope thereof. It is intended that the scope of the disclosure only be limited by the appended claims.

1. A bandwidth resource multiplexing method, comprising:
sending a resource configuration parameter, a resource indicated by the resource configuration parameter being configured for bandwidth resource multiplexing of a first type of user equipment (UE) and a second type of UE,
wherein the bandwidth resource multiplexing comprises at least one of:
physical random access channel (PRACH) resources of the first type of UE and the second type of UE partially or fully overlapping, or
initial uplink (UL) bandwidth parts (BWPs) of the first type of UE and the second type of UE partially or fully overlapping.

2. The method of claim 1, wherein a bandwidth supported by the second type of UE is greater than or equal to a bandwidth supported by the first type of UE.

3. The method of claim 2, wherein the resource configuration parameter comprises at least two sets of configuration parameters, wherein at least one set of configuration parameters is configuration parameters dedicated to the first type of UE.

4. The method of claim 3, wherein the resource configuration parameter comprises at least one of:
indication parameters configured to indicate random access preamble sets, wherein random access preambles contained in random access preamble sets corresponding to the first type of UE and the second type of UE are different;
resource parameters for the PRACH resources, wherein at least portions of the PRACH resources corresponding to the first type of UE and the second type of UE overlap;
resource parameters for the initial UL BWPs, wherein at least portions of the initial UL BWPs corresponding to the first type of UE and the second type of UE overlap;
indication parameters for a mapping relationship between synchronization signal blocks (SSBs) and PRACH resources, wherein the mapping relationship between the SSBs and the PRACH resources is configured for at least one of the first type of UE or the second type of UE to determine a PRACH resource used according to an accessed SSB; or
indication parameters for a mapping relationship between PRACH resources and initial UL BWPs, wherein the mapping relationship between the PRACH resources and the initial UL BWPs is configured for at least one of the first type of UE or the second type of UE to determine an initial UL BWP used according to a PRACH resource used.

5. The method of claim 1, wherein the resource configuration parameter comprises:
a set of configuration parameters corresponding to the first type of UE and the second type of UE.

6. The method of claim 5, wherein the set of configuration parameters comprises at least one of:
indication parameters for a random access preamble set corresponding to the first type of UE and the second type of UE, respectively;
resource parameters for PRACH resources corresponding to both the first type of UE and the second type of UE;
indication parameters for a mapping relationship between SSBs and PRACH resources that corresponds to both the first type of UE and the second type of UE; or
indication parameters for a mapping relationship between the PRACH resources and the initial UL BWPs corresponding to the second type of UE.

7. The method of claim 6, wherein the mapping relationship between the SSBs and the PRACH resources is configured to enable at least one of the first type of UE or the second type of UE to determine a PRACH resource used according to an accessed SSB.

8. (canceled)

9. The method of claim 1, wherein sending the resource configuration parameter comprises:
sending the resource configuration parameter via remaining minimum system information (RMSI).

10. A bandwidth resource multiplexing method, comprising:
receiving a resource configuration parameter, wherein a resource indicated by the resource configuration parameter is configured for bandwidth resource multiplexing of a first type of user equipment (UE) and second type of UE,
wherein the bandwidth resource multiplexing comprises at least one of:
physical random access channel (PRACH) resources of the first type of UE and the second type of UE partially or fully overlapping, or
initial uplink (UL) bandwidth parts (BWPs) of the first type of UE and the second type of UE partially or fully overlapping.

11. The method of claim 10, wherein
a bandwidth supported by the second type of UE greater than or equal to a bandwidth supported by the first type of UE.

12. The method of claim 11, wherein the resource configuration parameter comprises at least one of:
indication parameters for random access preamble sets, wherein random access preambles contained in random access preamble sets corresponding to the first type of UE and the second type of UE are different;
resource parameters for the PRACH resources, wherein at least portions of the PRACH resources corresponding to the first type of UE and the second type of UE overlap;
resource parameters for the initial UL BWPs, wherein at least portions of the initial UL BWPs corresponding to the first type of UE and the second type of UE overlap;
indication parameters for a mapping relationship between synchronization signal blocks (SSBs) and PRACH resources, wherein the mapping relationship between the SSBs and the PRACH resources is configured for at least one of the first type of UE or the second type of UE to determine a PRACH resource used according to an accessed SSB; or
indication parameters for a mapping relationship between PRACH resources and initial UL BWPs, wherein the mapping relationship between the PRACH resources and the initial UL BWPs is configured for at least one of the first type of UE or the second type of UE to determine an initial UL BWP used according to a PRACH resource used.

13. The method of claim 10, wherein the resource configuration parameter comprises:
a set of configuration parameters corresponding to the first type of UE and the second type of UE.

14. The method of claim 13, wherein the set of configuration parameters comprises at least one of:
indication parameters for random access preamble sets corresponding to the first type of UE and the second type of UE, respectively;
resource parameters for PRACH resources corresponding to both the first type of UE and the second type of UE;
indication parameters for a mapping relationship between SSBs and PRACH resources that corresponds to both the first type of UE and the second type of UE; or
indication parameters for a mapping relationship between the PRACH resources and the initial UL BWPs corresponding to the second type of UE.

15. The method of claim 14, wherein the mapping relationship between the SSBs and the PRACH resources is configured to enable at least one of the first type of UE or the second type of UE to determine a PRACH resource used according to an accessed SSB.

16. (canceled)

17. The method of claim 14, further comprising:
determining the initial UL BWP of the first type of UE according to at least one of the PRACH resource used by the first type of UE or a bandwidth supported by the first type of UE in response to the UE being the first type of UE.

18. The method of claim 10, wherein receiving the resource configuration parameter comprises:
receiving the resource configuration parameter via remaining minimum system information (RMSI).

19. (canceled)

20. (canceled)

21. A communication device, comprising:
a processor;
a transceiver; and
a memory storing a program executable by the processor,
wherein the processor is configured to:
send a resource configuration parameter, a resource indicated by the resource configuration parameter being configured for bandwidth resource multiplexing of a first type of user equipment (UE) and a second type of UE,
wherein the bandwidth resource multiplexing comprises at least one of:
physical random access channel (PRACH) resources of the first type of UE and the second type of UE partially or fully overlapping, or
initial uplink (UL) bandwidth parts (BWPs) of the first type of UE and the second type of UE partially or fully overlapping.

22. A non-transitory computer-readable storage medium having stored therein executable programs that, when executed by a processor, cause the processor to perform the method of claim 1.

23. A communication device, comprising:
a processor;
a transceiver; and
a memory storing a program executable by the processor,
wherein the processor is configured to perform the method of claim 10.

24. A non-transitory computer-readable storage medium having stored therein executable programs that, when executed by a processor, cause the processor to perform the method of claim 10.
